(19) United States
(12) Patent Application Publication
(10) Pub. No.: US 2009/0198868 A1
(43) Pub. Date: Aug. 6, 2009

(54) METHOD OF ACCESSING VIRTUAL STORAGE DEVICE THROUGH VIRTUAL DATA ROUTER

(75) Inventors: Xu-Ming ZHANG, Tianjin (CN); Tom CHEN, Taipei (TW); Win-Harn LIU, Taipei (TW)

Correspondence Address: Workman Nydegger;1000 Eagle Gate Tower, 60 East South Temple, Salt Lake City, UT, 84111, US

(73) Assignee: INVENTEC CORPORATION, Taipei (TW)

(21) Appl. No.: 12/026,809

(22) Filed: Feb. 6, 2008

(51) Int. Cl. G06F 12/00

(52) U.S. Cl. 711/101; 711/E12.001

(57) ABSTRACT

A method of accessing a virtual storage device through a virtual data router (VD router) is described. A virtual disk device on a controller may be accessed from various controllers through different paths based on asynchrony of data sending/receiving of a VD router. Moreover, the method is advantageous in having high access efficiency and consistency of data access via different paths at the same time.

### BACKGROUND OF THE INVENTION

1. Field of Invention

The present invention relates to a method of accessing a virtual storage device, and more particularly to a method of accessing a virtual storage device through a virtual data (VD) router.

2. Related Art

Currently, multi-path input output (MPIO) technology is widely utilized in a dual controller environment, for performing data storage and read/write operations on a network storage device. Through the MPIO technology, a network storage device is accessed via one or more physical links, and network storage applications become more adaptable with better performances by means of I/O scheduling strategies of fault tolerant, traffic load balance, and fine granularity.

The MPIO technology requires to make mapping backups of disk access paths, and to access a disk via any path. Therefore, when a path goes abnormal, another path may be used to access the storage device, thus preventing the services and connections from interruption.

When a disk is accessed, an established virtual logical volume manager (LVM) device may only be stored in a controller and can be directly accessed, but the question is how to access the same virtual device from another controller.

Currently, in the conventional art, a net bridge block device (NBD) is provided by the Linux system for performing the mapping of a remote device, i.e., to access a virtual device on another controller via network paths mapped between virtual block devices provided by the NBD. However, the NBD may cause many problems in use, and the major ones are listed below. (1) As a remote disk device is accessed completely by means of serialization, i.e., the next I/O operation will not be carried out until the previous I/O operation of the remote disk device is finished, the access through NBD is low in efficiency. (2) As the NBD has a system cache, the data obtained from the NBD is inconsistent with that obtained from a physical device at the same time, i.e., the phenomenon that the data read from the NBD (where a virtual mirror image device is established) is inconsistent with that read from a physical device at the same time may occur.

### SUMMARY OF THE INVENTION

To solve the problems and defects in the conventional art, the present invention is directed to a method of accessing a virtual storage device through a VD router. A virtual disk device on a controller may be accessed from various controllers through different paths based on asynchrony of data sending/receiving of a VD router.

The present invention provides a method of accessing a virtual storage device through a VD router. According to the method, a VD router is respectively disposed in each controller in a network storage environment with multiple controllers, so as to access a virtual disk device on a controller from different controllers. The method includes the following steps.

When a data read/write operation is to be performed on a virtual disk device, a data read/write request is packaged and then sent to a VD router of a local controller. The VD router determines whether the virtual disk device is located on the local controller according to a pre-stored mapping relationship between a logical unit number (LUN) and an actual logical volume (LV). If the virtual disk device is located on the local controller, a data read/write operation of a local device is performed on the virtual disk device, and the operation result is fed back to the VD router. If the virtual disk device is not located on the local controller, data to be read/written is packaged into a format of a VD router task, and the data read/write task is temporarily stored in a task queue and then sent to the remote controller where the virtual disk device is located. Then, the remote controller performs a data read/write operation on the virtual disk device, and feeds back the operation result to the local controller after the data read/write operation is finished. Thereby, the local controller queries, obtains, and then ends the corresponding data read/write task in the task queue according to relative information contained in the operation result, and subsequently feeds back the operation result of the data read/write task to the VD router.

In view of the above, the present invention has the following advantages.

A method of accessing a virtual storage device through a VD router is provided, such that a virtual disk device on a controller may be accessed from various controllers through different paths based on asynchrony of data sending/receiving of a VD router. As the mapping mechanism adopted by the method of the present invention is not a device-to-device mapping in the conventional art, but only a mapping of logic relationship of an LUN, a remote access request in accordance with a device is first packaged and sent to the device. Then, a read/write operation is performed on the device, and data sending and receiving are separated into different processes. That is, the sending of a data read/write request and the receiving of the result of the data read/write operation are performed separately, which is a completely asynchronous process. Thereby, the problem that data sending is blocked by data receiving due to the adoption of serialization to access a remote disk device in the conventional art is avoided, and it is unnecessary to wait for a long time before a slow I/O operation is finished. Meanwhile, the operation instruction may be properly optimized from a remote end, so as to reasonably integrate a series of small data I/O packets into a large data I/O packet to be sent out. In this manner, frequent network data transmission operations are reduced, and the utilization of network resources is effectively improved, thereby ensuring an unblocked simultaneous access of data read/write of an application program, and greatly enhancing the access efficiency. Further, in the method of the present invention, actual read and write operations to the virtual disk device both occur at the device, and the device only has one system cache, so it is easy to achieve and ensure the consistency of data access via different paths at the same time. In addition, as the VD router employed by the method of the present invention only has one operation process, the consumption of system resources required by frequent process switching in the conventional art can be reduced.

### BRIEF DESCRIPTION OF THE DRAWINGS

The present invention will become more fully understood from the detailed description given herein below for illustration only, and thus are not limitative of the present invention, and wherein:

FIG. 1 is a systematic block diagram of a system run by a method of accessing a virtual storage device through a VD router according to an embodiment of the present invention; and

FIG. 2 is a flow chart of a method of accessing a virtual storage device through a VD router according to the present invention.

### DETAILED DESCRIPTION OF THE INVENTION

Preferred embodiments of the present invention will be illustrated in detail below with the accompanying drawings.

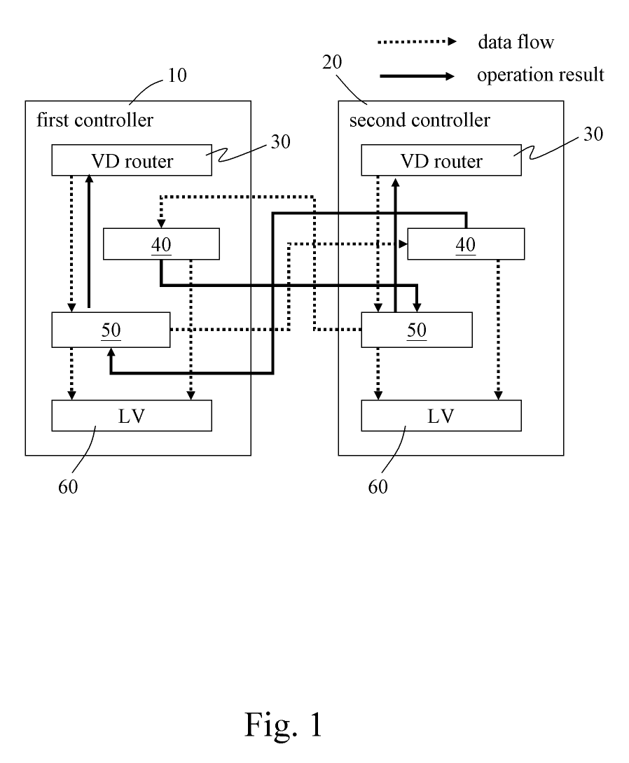

Referring to FIG. 1, a systematic block diagram of a system run by a method of accessing a virtual storage device through a VD router according to an embodiment of the present invention is shown. In FIG. 1, according to the system embodiment run by the method of the present invention, a VD router 30 is disposed in each controller in a dual controller network storage environment having a first controller 10 and a second controller 20, so as to access a virtual disk device on a controller from different controllers. In addition, it should be noted that the VD router is an indispensable part in the path backup technology for realizing MPIO, so as to access a virtual disk device on a controller from different storage controllers at the same time.

In the dual controller environment of FIG. 1, a VD router-server module 40 and a VD router-client module 50 are respectively disposed in the first controller 10 and the second controller 20. The VD router-server module 40 is used to realize a VD router-server process at the physical device. The main task of the process is to receive data sent from the remote VD router-client module 50 and respond the result of the data read/write operation to the remote VD router-client module 50. The VD router-server module 40 is mainly used for sending data.

When a data read/write operation is to be performed on a virtual disk device, a data read/write request is packaged and then sent by an upper layer to the VD router 30 of the first controller 10, the VD router 30 determines whether the virtual disk device is located on the local first controller 10 according to a pre-stored mapping relationship between an LUN and an actual LV.

If the virtual disk device is located on the local first controller 10, data is sent from the local VD router-client module 50 to an LV 60, such that a data read/write operation of a local device is performed on the virtual disk device, and the operation result is fed back to the VD router 30 and then reported to the upper layer.

If the virtual disk device is not located on the first local controller 10 but on the remote second controller 20, data to be read/written is packaged into the format of a VD router task, and the data read/write task is temporarily stored in a task queue. After that, the data is sent from the local VD router-client module 50 on the first controller 10 to the VD router-server module 40 on the remote second controller 20 where the virtual disk device is located. Then, the VD router-server module 40 sends the data to the LV 60, such that a data read/write operation is performed on the virtual disk device, and the VD router-server module 40 feeds back the operation result (success or failure) to the VD router-client module 50 on the first controller 10 after the data read/write operation is finished. Thereby, the VD router-client module 50 queries, obtains, and then ends the corresponding data read/write task in the task queue according to relative information contained in the operation result, and subsequently feeds back the operation result of the data read/write task to the VD router 30 and further reports to the upper layer.

In addition, the system run by a method of the present invention is not limited to the dual controller system architecture in FIG. 1, but may be a system architecture with more controllers. A system architecture with more controllers has no substantial difference from the dual controller system architecture in configuration, but each controller needs to store a copy of device mapping table and perform a VD router-server process, for handling multiple VD router requests. When a VD router request is generated, each controller determines the controller where the device is located according to the device mapping table, and then sends the request to the corresponding controller. When an operation result is to be fed back, each controller determines which one the operation result is to be fed back to according to relative information contained in the request about the controller that sends the request.

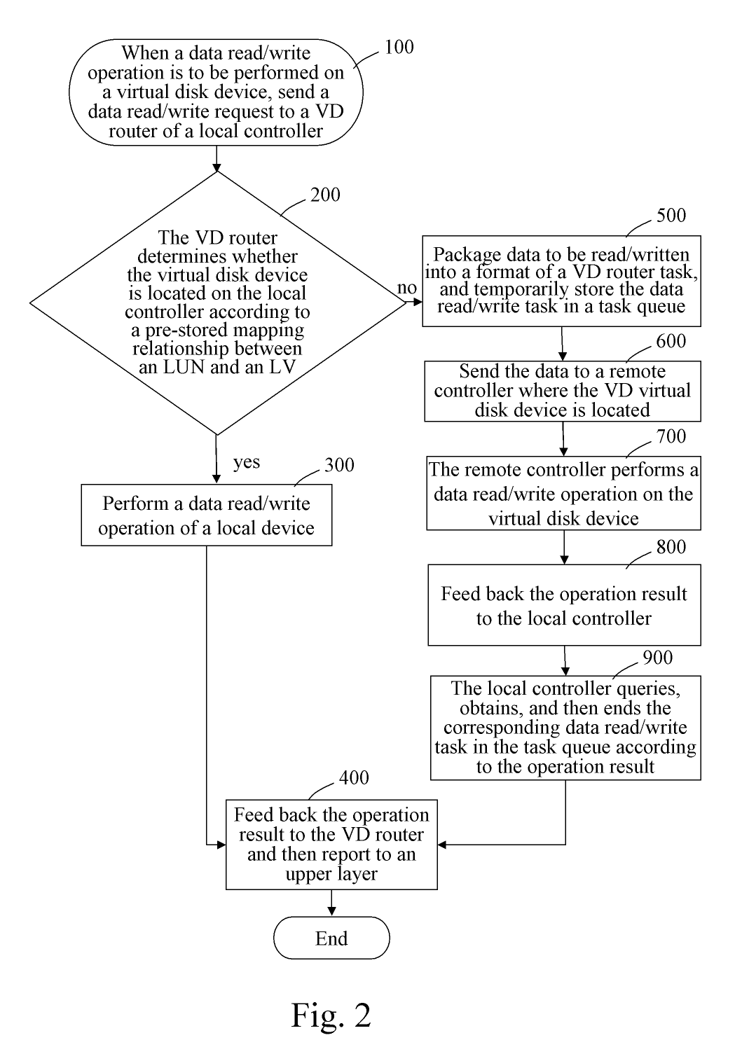

Now referring to FIG. 2, a flow chart of a method of accessing a virtual storage device through a VD router according to the present invention is shown. In FIG. 2, according to the method of the present invention, a VD router is disposed in each controller in a network storage environment having multiple (two or more) controllers, so as to achieve the purpose of accessing a virtual disk device on a controller from different controllers. The method includes the following steps.

First, when a data read/write operation is to be performed on a virtual disk device, a data read/write request is packaged and then sent to a VD router of a local controller (Step 100).

Next, the VD router determines whether the virtual disk device is located on the local controller according to a pre-stored mapping relationship between an LUN and an actual LV (Step 200).

If the virtual disk device is located on the local controller, a data read/write operation of a local device is performed on the virtual disk device (Step 300), and the operation result is fed back to the VD router and then reported to an upper layer (Step 400).

On the contrary, if the virtual disk device is not located on the local controller, data to be read/written is packaged into the format of a VD router task, and the data read/write task is temporarily stored in a task queue (Step 500). Then, the data is sent to a remote controller where the VD virtual disk device is located (Step 600), and a data read/write operation is performed by the remote controller on the virtual disk device (Step 700). After the data read/write operation is finished, the remote controller feeds back the operation result to the local controller (Step 800). Thereby, the local controller queries, obtains, and then ends the corresponding data read/write task in the task queue according to relative information contained in the operation result (Step 900), and subsequently feeds back the operation result of the data read/write task to the VD router and further reports to the upper layer (Step 400).

What is claimed is:

1. A method of accessing a virtual storage device through a virtual data router (VD router), wherein a VD router is disposed in each controller in a network storage environment having multiple controllers, so as to access a virtual disk device on a controller from different controllers, the method comprising:
when a data read/write operation is to be performed on a virtual disk device, sending a data read/write request to a VD router of a local controller;
the VD router determining whether the virtual disk device is located on the local controller according to a pre-stored mapping relationship between a logical unit number (LUN) and an actual logical volume (LV);
if the virtual disk device is located on the local controller, performing a data read/write operation of a local device on the virtual disk device, and feeding back an operation result to the VD router; and
if the virtual disk device is not located on the local controller, packaging data to be read/written into a format of a VD router task, and temporarily storing the data read/write task in a task queue, then sending the data to a remote controller where the virtual disk device is located, and performing a data read/write operation by the remote controller on the virtual disk device, wherein after the data read/write operation is finished, the remote controller feeds back the operation result to the local controller, such that the local controller queries and obtains the corresponding data read/write task in the task queue according to relative information contained in the operation result, and subsequently feeds back the operation result of the data read/write task to the VD router.

2. The method of accessing a virtual storage device through a VD router as claimed in claim 1, before sending a data read/write request to a VD router of a local controller, further comprising packaging the data read/write request.

3. The method of accessing a virtual storage device through a VD router as claimed in claim 1, after querying and obtaining the corresponding data read/write task from the task queue, further comprising ending the data read/write task.

4. The method of accessing a virtual storage device through a VD router as claimed in claim 1, wherein the number of the multiple controllers is two or more.
